(19) United States
(12) Patent Application Publication
(10) Pub. No.: US 2025/0273988 A1
(43) Pub. Date: Aug. 28, 2025

(54) ANALYSIS DEVICE, ANALYSIS SYSTEM, AND PROGRAM

(71) Applicant: FANUC CORPORATION, Minamitsuru-gun, Yamanashi (JP)

(72) Inventor: Shougo SHINODA, Yamanashi (JP)

(21) Appl. No.: 18/858,947

(22) PCT Filed: Jun. 16, 2022
(86) PCT No.: PCT/JP2022/024069

§ 371 Date: Oct. 22, 2024

(51) Int. Cl. H02J 13/00

(52) U.S. Cl. CPC H02J 13/00002; H02J 13/00001

(57) ABSTRACT

An analysis device of an embodiment comprises an acquisition unit, a decision unit, and a determination unit. The acquisition unit acquires an operating situation of at least one power consuming source. The decision unit uses the operating situation to decide, at each time slot, which operating state the power consuming source is in among a plurality of operating states having different power consumption, for each classification among a plurality of classifications based on conditions. The determination unit determines a time slot in which at least a prescribed proportion of classifications among the classifications are the same operating state.

### TECHNICAL FIELD

The present invention relates to an analysis device, an analysis system, and a program.

### BACKGROUND ART

Visualization of power consumption has been developed in an effort to promote energy saving.

### CITATION LIST

### Patent Document

Patent Document 1: Japanese Unexamined Patent Application, Publication No. 2019-144966

### DISCLOSURE OF THE INVENTION

### Problems to be Solved by the Invention

However, the conventional visualization of power consumption requires that an observer himself/herself assess the trend of the status of power consumption.

Embodiments of the present invention solve the problem of providing an analysis device, an analysis system, and a program that are capable of assessing the trend of a power consumption status.

### Means for Solving the Problems

An analysis device according to embodiments includes an obtainment unit, a determination unit, and a decision unit. The obtainment unit obtains the operation status of at least one power consumer. By using the operation status, the determination unit determines, for each of time slots and for each of a plurality of classifications provided according to a condition, an operation state that the power consumer is in from among a plurality of operation states each involving different power consumption. The decision unit decides a time slot during which at least a prescribed proportion of the classifications share a common operation state.

### Effects of the Invention

The present invention is capable of deciding the trend of a power consumption status.

### BRIEF DESCRIPTION OF THE DRAWINGS

FIG. 1 is a block diagram illustrating an analysis system 1 according to embodiments and an example of main configurations of components included in the analysis system 1;

FIG. 2 is a flowchart illustrating an example of processing performed by the processor in FIG. 1;

FIG. 3 is a flowchart illustrating an example of processing performed by the processor in FIG. 1;

FIG. 4 illustrates an example of a classification window displayed on the display device in FIG. 1; and

FIG. 5 illustrates an example of a classification window displayed on the display device in FIG. 1.

### PREFERRED MODE FOR CARRYING OUT THE INVENTION

The following describes an analysis system according to embodiments by referring to the drawings. The scale of parts in the drawings used for the description of the embodiments hereinafter may be changed as appropriate. Components in the drawings used for the description of the embodiments hereinafter may be omitted for the purpose of description. Identical reference marks denote similar elements herein and in the drawings.

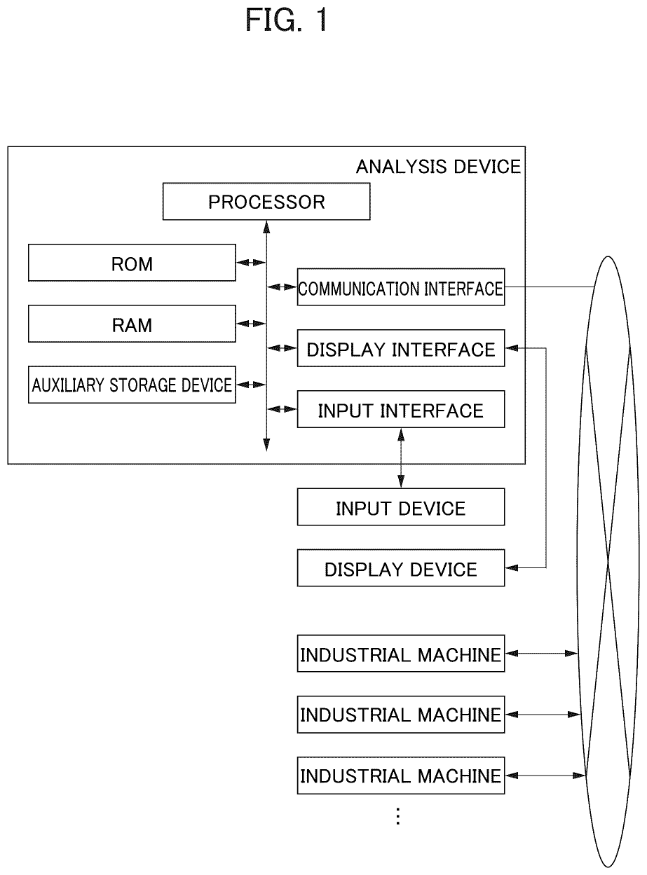

FIG. 1 is a block diagram illustrating an analysis system 1 according to embodiments and an example of main configurations of components included in the analysis system 1. The analysis system 1 analyzes the power consumption status of an industrial machine 400. As an example, the analysis system 1 includes an analysis device 100, a display device 200, an input device 300, and the industrial machine 400. FIG. 1 depicts one analysis device 100, one display device 200, one input device 300, and a plurality of industrial machines 400. However, the numbers of devices are not limited.

For example, the analysis device 100 and the industrial machines 400 connect to a network NW. For example, the network NW is a communication network including the Internet. For example, the network NW is a communication network including a wide area network (WAN). For example, the network NW is a communication network including a private network such as an intranet. For example, the network NW is a communication network including a local area network (LAN). The network NW may be a wireless channel or a wired channel, or may be a combination of a wireless channel and a wired channel. The network NW may also be a communication network including, for example, an exclusive line or a public mobile telephone network.

The analysis device 100 obtains information indicating the status of the power consumption of an industrial machine 400. The analysis device 100 also analyzes the power consumption status of the industrial machine 400 by using the obtained information. The analysis device 100 may be a numerical control device. As an example, the analysis device 100 includes a processor 101, a read-only memory (ROM) 102, a random-access memory (RAM) 103, an auxiliary storage device 104, a communication interface 105, a display interface 106, and an input interface 107. These components are connected by, for example, a bus 108.

The processor 101, which is a key section of a computer that performs processing such as computation and control required for operations of the analysis device 100, performs, for example, various types of computation and control. For example, the processor 101 is a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of a plurality of ones of these elements. The processor 101 may also be these elements with, for example, a hardware accelerator combined therewith. In order to implement various types of functions of the analysis device 100, the processor 101 controls each component on the basis of programs such as firmware, system software, and application software stored in, for example, the ROM 102 or the auxiliary storage device 104. The processor 101 also performs the processing described hereinafter on the basis of the programs. Some of or all of the programs may be incorporated into a circuit of the processor 101.

The ROM 102 and the RAM 103 are main storage devices for the computer that has the processor 101 as a key component.

The ROM 102 is a nonvolatile memory used exclusively for data reading. The ROM 102 stores, for example, the firmware from among the abovementioned programs. The ROM 102 also stores, for example, data used by the processor 101 when performing various types of processing.

The RAM 103 is used for data writing. The RAM 103 is used as, for example, a work area in which is stored data that is temporarily used by the processor 101 when performing various types of processing. The RAM 103 is typically a volatile memory.

The auxiliary storage device 104 is one for the computer that has the processor 101 as a key component. The auxiliary storage device 104 is, for example, an electric erasable programmable read-only memory (EEPROM), a hard disk drive (HDD), or a flash memory. The auxiliary storage device 104 stores, for example, the system software and the application software from among the abovementioned programs. The auxiliary storage device 104 also stores, for example, data used by the processor 101 when performing various types of processing, data generated through the processing performed by the processor 101, and various types of setting values.

The communication interface 105 allows the analysis device 100 to communicate with, for example, the industrial machines 400 via the network NW or the like. Note that the analysis system 1 may be configured such that the analysis device 100 and the industrial machines 400 communicate with each other without the intervention of the network NW.

The display interface 106 allows the analysis device 100 to communicate with the display device 200. The analysis device 100 controls the display device 200 via the display interface 106.

The display device 200 displays a window for notifying the operator of the analysis device 100 of various types of information. For example, the display device 200 is a liquid-crystal display or an organic electro-luminescence (EL) display. The display device 200 may be installed in the analysis device 100. The display device 200 is an example of the display unit.

The input interface 107 allows the analysis device 100 to communicate with the input device 300. The analysis device 100 receives, via the input interface 107, the input of operation inputs to the input device 300.

The input device 300 accepts an operation performed by the operator of the analysis device 100. For example, the input device 300 is a keyboard, a keypad, a touch pad, a mouse, or a controller. The input device 300 may be a device for speech input. The input device 300 may be installed in the analysis device 100.

The display device 200 and the input device 300 may be a touch panel. The touch panel functions as the display device 200 and the input device 300.

The bus 108 includes, for example, a control bus, an address bus, and a data bus and carries signals communicated between the components of the analysis device 100.

The industrial machines 400 are operated by consuming power. For example, the industrial machines 400 are machine tools, robots, air-conditioning machines, construction machines, or other industrial machines. At least two of the industrial machines 400 may be of the same type, or may be of different types from each other.

The industrial machines 400 are an example of the power consumer.

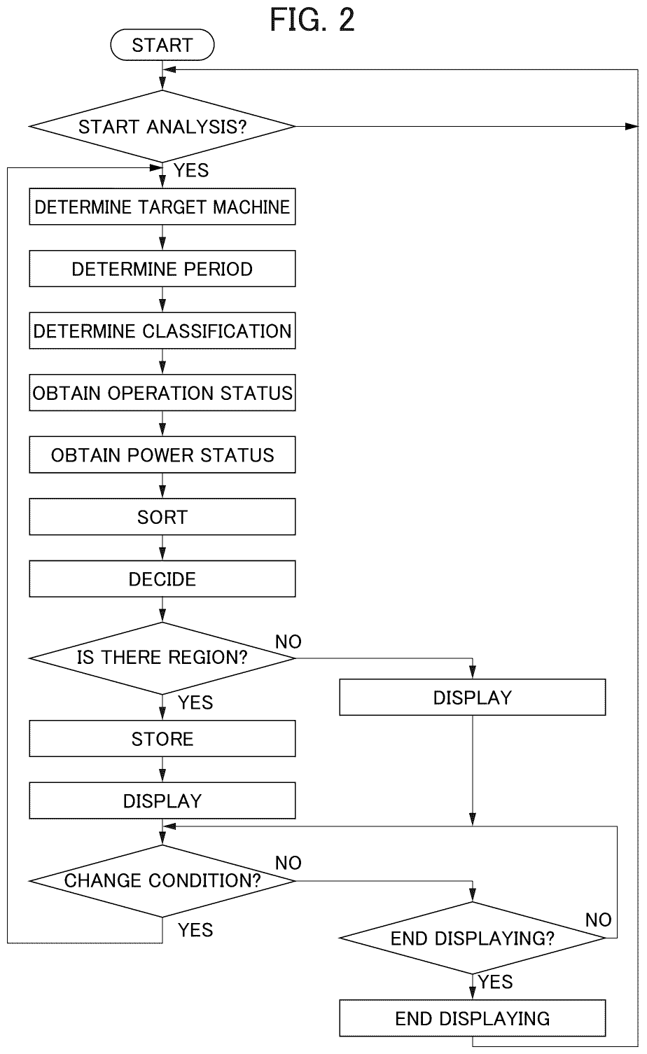

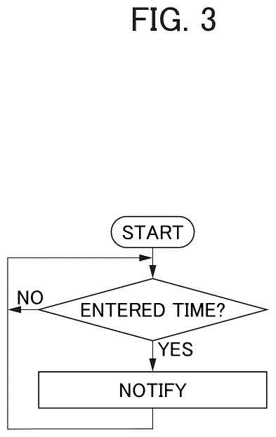

The following describes operations of the analysis system 1 according to embodiments on the basis of, for example, FIGS. 2 and 3. Details of the processing in the following descriptions of operations are exemplary, and various types of processing with which similar results can be obtained may be used, as appropriate. FIGS. 2 and 3 are flowcharts illustrating an example of processing performed by the processor 101 of the analysis device 100. The processor 101 performs the processing in FIGS. 2 and 3 on the basis of a program stored in, for example, the ROM 102 or the auxiliary storage device 104.

For example, the processor 101 performs the processing in FIG. 2 and the processing in FIG. 3 in tandem or parallel.

In Step ST11 in FIG. 2, the processor 101 of the analysis device 100 decides whether to start to analyze the power consumption status of an industrial machine 400. For example, when a prescribed time has come, the processor 101 decides to start to analyze a power consumption status. For example, when an operation input for instructing the analysis device 100 to start to analyze a power consumption status has been provided to the input device 300, the processor 101 decides to start to analyze the power consumption status. When information for instructing the analysis device 100 to start to analyze a power consumption status has been input via the communication interface 105 from, for example, another device, the processor 101 decides to start to analyze a power consumption status. When the processor 101 does not decide to start to analyze a power consumption status, the processor 101 gives a decision of No in Step ST11 and then repeats the process of Step ST11. By contrast, when the processor 101 does decide to start to analyze a power consumption status, the processor 101 gives a decision of Yes in Step ST11 and then shifts to Step ST12.

In Step ST12, the processor 101 determines for which of the industrial machines 400 a power consumption status is to be analyzed. Note that the industrial machine 400 determined in Step ST12 as one for which a power consumption status is to be analyzed is hereinafter referred to as a “target machine.” One industrial machine 400 may be a target machine, or a plurality of industrial machines 400 may be target machines.

For example, the processor 101 selects a preset industrial machine 400 as a target machine. For example, the processor 101 determines a target industrial machine 400 in accordance with an operation input to the input device 300. For example, the processor 101 determines a target industrial machine 400 in accordance with information input from another device.

A target machine may be determined according to, for example, a condition. For example, the condition for determining a target machine (hereinafter referred to as “machine conditions”) is input to the analysis device 100 in accordance with an operation input to the input device 300. For example, the machine condition is input to the analysis device 100 from another device via the communication interface 105. The processor 101 selects an industrial machine 400 meeting the machine condition as a target machine.

The following (A1) to (A7) are presented as examples of the machine condition.

(A1) Being an industrial machine 400 of a specific model.

(A2) Being an industrial machine 400 that performs a specific operation. The specific operation is, for example, specific machining work.

(A3) Being an industrial machine 400 that is operated by a specific program. The specific program is, for example, a machining program or an NC program.

(A4) Being an industrial machine 400 that is managed or operated by, for example, a specific person in charge, worker, or team.

(A5) Being an industrial machine 400 that was operated during a specific period.

(A6) Being an industrial machine 400 of which the power was on during a specific period.

(A7) Being an industrial machine 400 installed in a specific location.

The machine condition may be obtained by combining a plurality of conditions by using, for example, logical computation.

However, if none of the industrial machines 400 meet the machine condition, the processor 101 performs, for example, error processing. As the error processing, the processor 101 notifies, for example, the operator of the analysis device 100 that none of the industrial machines 400 meet the machine condition by, for example, causing the display device 200 to display an image indicating that none of the industrial machines 400 meet the machine condition.

In Step ST13, the processor 101 determines a period during which the power consumption status is to be analyzed (hereinafter referred to as a “target period”). For example, the processor 101 selects a preset period as a target period. For example, the processor 101 determines a target period in accordance with an operation input to the input device 300. For example, the processor 101 determines a target period in accordance with information input from another device.

In Step ST14, the processor 101 determines a classification condition. It is indicated how the power consumption status of the target machine is classified and displayed. For example, the processor 101 uses a preset classification condition. For example, the processor 101 determines a classification condition in accordance with an operation input to the input device 300. For example, the processor 101 determines a classification condition in accordance with information input from another device.

The following (B1) to (B8) are presented as examples of the classification condition.

(B1) For each day of the week

(B2) For each day

(B3) For each prescribed period

(B4) For each model of target machine

(B5) For each operation performed by the target machine

(B6) For each program used by the target machine

(B7) For each person in charge, worker, or team that manages or operates the target machine

(B8) For each location in which a target machine is installed

In Step ST15, the processor 101 obtains operation information pertaining to the target machine for the target period. When there are a plurality of target machines, the processor 101 obtains operation information pertaining to the plurality of target machines. The operation information indicates the history of the operation state of the target machine. Operation states include, for example, a power-OFF state, a stopped state, an active state, and an alarm state, and indicate the operation status of industrial machines 400. The operation states are different in power consumption. An industrial machine 400 in the power-OFF state has not been powered on. An industrial machine 400 in the stopped state, the active state, or the alarm state has been powered on. An industrial machine 400 in the stopped state is not performing an operation. An industrial machine 400 in the active state is performing an operation. An industrial machine 400 in the alarm state has stopped performing a normal operation due to the occurrence of an error, and is performing an operation for notifying, for example, nearby persons and operators that an error has occurred by, for example, giving an alarm.

For example, an operation performed by an industrial machine 400 is one for machining a workpiece. Alternatively, the operation is one for machining a workpiece or for moving an axis for machining the workpiece. The machining of the workpiece is, for example, laser beam machining, gas cutting machining, or electric discharge machining.

The processor 101 obtains operation information from, for example, the target machine or a device that controls the target machine. The processor 101 may obtain operation information in advance and store the same in, for example, the auxiliary storage device 104. In this case, the processor 101 obtains operation information from, for example, the auxiliary storage device 104.

Accordingly, by performing the process of Step ST15, the processor 101 functions as an example of the obtainment unit that obtains the operation status of at least one power consumer.

In Step ST16, the processor 101 obtains power information pertaining to the target machine for the target period. The power information is the history of power consumption of the industrial machine 400 or the history of the amount of power consumption of the industrial machine 400 per unit time.

The processor 101 obtains power information from, for example, the target machine or a device that controls the target machine. The processor 101 may obtain power information in advance and store the same in, for example, the auxiliary storage device 104. In this case, the processor 101 obtains power information from, for example, the auxiliary storage device 104.

The processor 101 may obtain the operation status of the target machine by estimating the operation state of the target machine from the power consumption of the target machine. In this case, the processor 101 does not need to obtain operation information. For example, when the power consumption of the target machine is greater than a threshold TH1, the processor 101 considers that the target machine is in the active state. When the power consumption of the target machine is no greater than the threshold TH1 and greater than a threshold TH2, the processor 101 considers that the target machine is in the stopped state. When the power consumption of the target machine is equal to or less than the threshold TH2, the processor 101 considers that the target machine is in the power-OFF state.

When the power consumption of the target machine is greater than the threshold TH1 and no greater than a threshold TH3, the processor 101 may consider that the target machine is in the alarm state. In this case, when the power consumption of the target machine is greater than the threshold TH3, the processor 101 considers that the target machine is in the active state.

The thresholds TH1 to TH3 are each preset by, for example, a person who designs or manages the analysis system 1. The thresholds TH1 to TH3 usually differ according to the type of the industrial machine 400. The thresholds TH1 to TH3 have a magnitude relationship of TH3>TH1>TH2.

For example, the threshold TH1 is power that is greater than the power consumption observed when the industrial machine 400 is powered on but is not activated.

For example, the threshold TH2 is 0 watts. Alternatively, the threshold TH2 is equal to or greater than, for example, power corresponding to the standby power of the industrial machine 400.

For example, the threshold TH3 is power that is greater than the power consumption observed when the industrial machine 400 is in the alarm state.

Accordingly, the processor 101 functions as an example of the obtainment unit that obtains the operation status of at least one power consumer by estimating the operation state of the target machine from the power consumption of the target machine.

In Step ST17, the processor 101 classifies the operation state of the target machine according to a classification condition.

The processor 101 investigates the operation state of the target machine for each classification and for each time slot by using at least either the information obtained in Step ST15 or the information obtained in Step ST16. For example, when the classification condition is “(B1) For each day of the week,” the processor 101 investigates the operation status for each time slot and for each of the seven classifications of Sunday to Saturday. In particular, the processor 101 investigates, for example, the operation statuses on Sunday at 0:00 to 1:00, 1:00 to 2:00, . . . , and 23:00 to 24:00, the operation statuses on Monday at 0:00 to 1:00 and., and the operation statuses on Saturday at 23:00 to 24:00. Although the width of each time slot is one hour in this example, the width is not limited to one hour.

When there is one target machine, the processor 101 considers that the operation state observed for the longest time within a time slot is the operation state during this time slot. For example, when the power-OFF state and the active state are respectively observed for 20 minutes and 40 minutes within a time slot of one hour, the operation state during this one hour is the active state. When the target period includes a plurality of periods of the same time slot in the same classification, it is considered that the operation state observed for the longest time within the total of the plurality of periods of this time slot is the operation state during this time slot. For example, when the target period includes three Mondays, the processor 101 considers that the operation state observed for the longest time within the total period of three hours on the three days at 1:00 to 2:00 is the operation state during the period of 1:00 to 2:00 on Monday.

For example, when there are a plurality of target machines, the processor 101 determines, for each target machine, the operation state during a time slot. For each operation state, the processor 101 counts the number of target machines in the operation state. The processor 101 considers that the operation state that the most target machines are in is the operation state during the time slot. For example, when one target machine, three target machines, five target machines, and no target machines are respectively in the power-OFF state, the stopped state, the active state, and the alarm state on Tuesday at 13:00 to 14:00, the processor 101considers that the operation state of the target machines on Tuesday at 13:00 to 14:00 is the active state.

Alternatively, when there are a plurality of target machines, for example, the processor 101 totalizes the time lengths of each operation state of the plurality of target machines, and considers that the operation state with the longest time length is the operation state during that time slot. As an example, consideration is given to the operation state on Wednesday at 15:00 to 16:00 with the presence of three target machines. The three target machines are a target machine X1 to a target machine X3. The target period includes two Wednesdays. The operation states of the target machine X1 on Wednesday at 15:00 to 16:00 include 10 minutes of power-OFF state, 20 minutes of stopped state, 90 minutes of active state, and 0 minutes of alarm state. The operation states of the target machine X2 on Wednesday at 15:00 to 16:00 include 0 minutes of power-OFF state, 60 minutes of stopped state, 60 minutes of active state, and 0 minutes of alarm state. The operation states of the target machine X3 on Wednesday at 15:00 to 16:00 include 20 minutes of power-OFF state, 80 minutes of stopped state, 20 minutes of active state, and 0 minutes of alarm state. In this case, the total of the power-OFF state is 30 minutes, the total of the stopped state is 160 minutes, and the total of the active state is 170 minutes.

Since the active state is the longest in time, the processor 101 determines that the operation state on Wednesday at 15:00 to 16:00 is the active state.

When the classification condition is “(B2) For each day,” the processor 101 investigates, with each day within the target period being one classification, an operation status for each day and for each time slot.

When the classification condition is “(B3) For each month,” the processor 101 divides the target period into prescribed periods, and investigates, with each single prescribed period being one classification, an operation status for each prescribed period and for each time slot. For example, it should be assumed that: the target period is six weeks; and the prescribed period is one week. In this case, the processor 101 investigates the operation status for each time slot for six classifications of the first week to the sixth week.

When the classification condition is “(B4) For each model of target machine,” the processor 101 investigates the operation status for each model of target machine and for each time slot within the target period. As noted above, when the target period includes a plurality of periods of the same time slot in the same classification, it is considered that the operation state observed for the longest time within the total of the plurality of periods of this time slot is the operation state during this time slot. Accordingly, when, for example, the target period is seven days, the processor 101 determines the operation state of a certain model during the period of 15:00 to 16:00 such that the operation state observed for the longest time within the total of seven hours of the periods of time slot of 15:00 to 16:00 on the seven days is the operation state of this model during the time slot of 15:00 to 16:00.

Similarly, when the classification condition is, for example, “(B5) For each operation performed by the target machine,” “(B6) For each program used by the target machine,” “(B7) For each person in charge, worker, or team that manages or operates the target machine,” or “(B8) For each location in which a target machine is installed,” the processor 101 investigates the operation status for each classification condition and for each time slot within the target period.

The processor 101 may also determine the operation status of the target machine for each time slot by using, for example, other statistical techniques.

Accordingly, the processor 101 functions as an example of the determination unit that determines, by using the operation status and for each of the time slots and for each of the plurality of classifications provided according to a condition by performing the process of Step ST17, an operation state that the power consumer is in from among a plurality of operation states each involving different power consumption.

In Step ST18, the processor 101 decides whether there is an assessment region in the classification result from Step ST17. The processor 101 also decides which region is the assessment region. For example, when the operation status of the target machine is represented as a matrix table having classification and time slot as a vertical item and a horizontal item, the assessment region is a region in the table for which it has been assessed that power consumption can possibly be decreased. When there is a time slot during which a classification with the stopped state as the operation state accounts for at least a prescribed proportion, the processor 101 decides that there is an assessment region in this time slot. The processor 101 also considers that a region of stopped state, from among time slots with an assessment region, is an assessment region.

As an example, it should be assumed that: the prescribed proportion is 70%; and the number of classifications is seven. In this case, if there is a time slot in which at least 70% of the seven classifications, i.e., at least five classifications, exhibit the stopped state, this time slot includes an assessment region. Assume, for example, that, during the time slot of 12:00 to 13:00, five classifications of Monday to Friday exhibit the stopped state, and two classifications of Sunday and Saturday exhibit the power-OFF state. In this case, the time slot of 12:00 to 13:00 includes an assessment region. Meanwhile, since the assessment region is the portions of the time slot of 12:00 to 13:00 that exhibit the stopped state, the time slot of 12:00 to 13:00 on each of Monday to Friday is an assessment region. Note that the prescribed proportion may be 100%.

Accordingly, by performing the process of Step ST19, the processor 101 functions as an example of the decision unit that decides a time slot during which at least a prescribed proportion of the classifications share a common operation state.

In Step ST19, the processor 101 decides whether there is an assessment region on the basis of the processing result from the Step ST18. When there is an assessment region, the processor 101 gives a decision of Yes in Step ST19 and shifts to Step ST20.

In Step ST20, the processor 101 stores assessment information in, for example, the auxiliary storage device 104, the assessment information indicating which industrial machine 400 is the target machine and which portion is the assessment region.

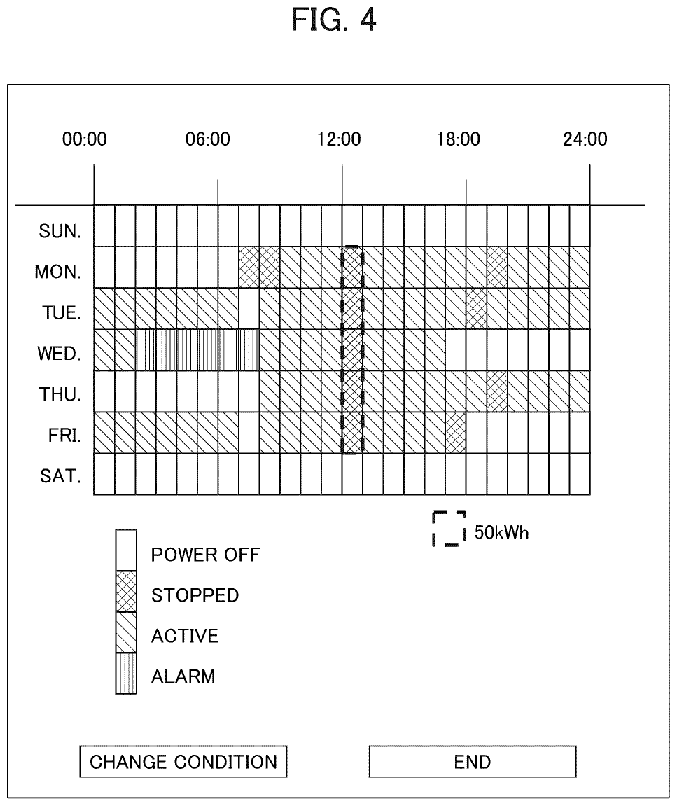

In Step ST21, the processor 101 generates an image that corresponds to a classification window SC1 such as that depicted in FIG. 4. The processor 101 instructs the display device 200 to display the generated image. Upon receipt of the instruction to display, the display device 200 displays the classification window SC1.

FIG. 4 illustrates an example of the classification window SC1. The classification window SC1 displays, for example, the processing results from Steps ST17 and ST18. For example, the classification window SC1 includes a region AR1 to a region AR3, a button BT1, and a button BT2.

The region AR1 represents the operation status of the target machine as a matrix table having classification and time slot as a vertical item and a horizontal item. In FIG. 4, the vertical item is classification, and the horizontal item is time slot. In this way, the table indicated in the region AR1 displays aligned time axes for the individual classifications. In FIG. 4, the classification is “day of the week.”

Thus, the classification condition is “(B1) For each day of the week.”

Meanwhile, the width of each time slot is one hour in FIG. 4.

The region AR1 may include regions AR11 to regions AR15.

The regions AR11 to the regions AR14 display an operation state for each classification and for each time slot. The regions AR11 to AR14 are different from each other in appearance. In this way, it can be found that which cell in the table corresponds to which of the regions AR11 to AR14. The processor 101 makes the regions AR11 to AR14 different in appearance by, for example, providing these regions with different colors or patterns.

The regions AR11 indicate the power-OFF state.

The regions AR12 indicate the stopped state.

The regions AR13 indicate the active state.

The regions AR14 indicate the alarm state.

The regions AR15 indicate an assessment region. In FIG. 4, the periods of time slot of 12:00 to 13:00 on Monday to Friday are regions AR15.

A region AR2 indicates legends for the regions AR11 to AR14.

A region AR3 is the amount of power consumption that can be avoided if the target machine is switched from the stopped state to the power-OFF state during a time slot corresponding to an assessment region. For example, the processor 101 obtains the amount of avoidable power consumption in accordance with an expression of ((power consumption during stopped state)−(power consumption during power-OFF state))×(number of cells included in assessment region)×(width of one time slot)×(number of target machines). Alternatively, the processor 101 obtains the amount of avoidable power consumption in accordance with an expression of ((power consumption during stopped state)−(power consumption during power-OFF state))×(total of time lengths of stopped state within time slots in assessment regions for individual target machines). Alternatively, the processor 101 obtains the amount of avoidable power consumption in accordance with the total value of the amounts of power consumption during the stopped state in time slots corresponding to assessment regions for individual target machines. Note that the power consumption during the power-OFF state may be 0.

The button BT1 is operated when changing at least the target machine, the target period, or the classification condition.

The button BT2 is operated when ending the displaying of the classification window SC1.

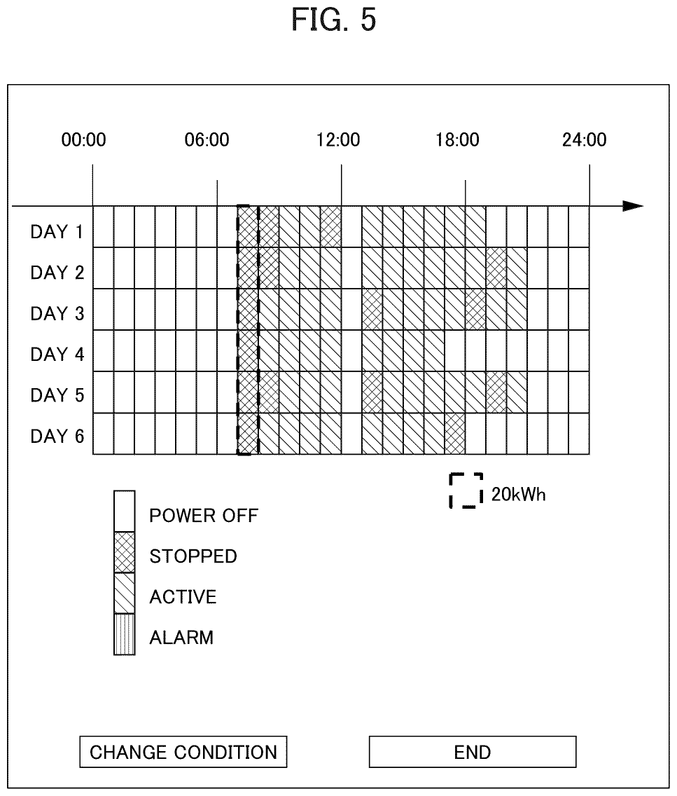

FIG. 5 depicts a classification window SC1b as another example of the classification window SC1. FIG. 5 illustrates an example of the classification window SC1b. In the classification window SC1b depicted in FIG. 5, the classification is “each day.”

Thus, the classification condition is “(B2) For each day.” In particular, the target period is six days of Day 1 to Day 6. As a result, the operation state of the target machine is classified into six states for Day 1 to Day 6. Meanwhile, the width of each time slot is one hour in FIG. 5.

Accordingly, by performing the process of Step ST21, the processor 101 functions as an example of the display control unit that causes a display unit to display an operation state for each of the time slots and for each of the classifications for which the determination unit has made the determination, and to display the time slot decided by the decision unit.

When there are no assessment regions, the processor 101 gives a decision of No in Step ST22 and shifts to Step ST22.

In Step ST22, the processor 101 generates an image that corresponds to the classification window SC1. The processor 101 instructs the display device 200 to display the generated image. Upon receipt of the instruction to display, the display device 200 displays the classification window SC1.

Unlike the classification window SC1 displayed in Step ST21, the classification window SC1 displayed in Step ST22 includes no regions AR15.

After the process of Step ST21 or ST22, the processor 101 shifts to Step ST23.

In Step ST23, the processor 101 decides whether an operation for changing at least the target machine, the target period, or the classification condition has been performed. In particular, the processor 101 decides whether a preset operation, such as operating the button BT1, has been performed. When an operation for changing at least the target machine, the target period, or the classification condition has not been performed, the processor 101 gives a decision of No in Step ST23, and shifts to Step ST24.

In Step ST24, the processor 101 decides whether an operation for ending the displaying of the classification window SC1 has been performed. In particular, the processor 101 decides whether a preset operation, such as operating the button BT2, has been performed. When an operation for ending the displaying of the classification window SC1 has not been performed, the processor 101 gives a decision of No in Step ST24, and returns to Step ST23. In this way, the processor 101 is placed in a standby state of repeating Steps ST23 and ST24 until an operation for changing at least the target machine, the target period, or the classification condition is performed or an operation for ending the displaying of the classification window SC1 is performed.

When an operation for changing at least the target machine, the target period, or the classification condition is performed during the standby state for Steps ST23 and ST24, the processor 101 gives a decision of Yes in Step ST23, and returns to Step ST12.

When an operation for ending the displaying of the classification window SC1 is performed during the standby state for Steps ST23 and ST24, the processor 101 gives a decision of Yes in Step ST24, and shifts to Step ST25.

In Step ST25, the processor 101 ends the displaying of the classification window SC1 by controlling the display device 200. After the process of Step ST25, the processor 101 returns to Step ST11.

In Step ST31 in FIG. 3, meanwhile, the processor 101 of the analysis device 100 refers to assessment information stored in, for example, the auxiliary storage device 104 so as to decide whether the current time has entered a time slot including an assessment region. For example, when the time slot from 16:00 to 17:00 includes an assessment region, the processor 101 decides that the current time has entered a time slot including an assessment region when the current time has reached or passed 16:00. When the classification condition is “(B9) For each day of the week,” even when the current time has entered a time slot including an assessment region, the processor 101 does not need to decide that the current time has entered a time slot including an assessment region unless the time slot is within the assessment region for the current day of the week. When not deciding that the current time has entered an assessment region, the processor 101 gives a decision of No in Step ST31 and then repeats the process of Step ST31. When having decided that the current time has entered an assessment region, the processor 101 gives a decision of Yes in Step ST31 and shifts to Step ST32.

In Step ST32, the processor 101 notifies, for example, the operator of the analysis device 100 or nearby persons that the industrial machine 400 indicated by the assessment information should be powered off. The processor 101 provides notification by, for example, causing the display device 200 to display this fact. Alternatively, the processor 101 may provide notification by using a device other than the display device 200, such as causing a speaker to output speech indicating the fact. After the process of Step ST32, the processor 101 returns to Step ST31.

Accordingly, by performing the process of Step ST32, the processor 101 functions as an example of the notification unit that notifies that the current time has reached a time decided by the decision unit.

According to the analysis system 1 in embodiments, the analysis device 100 determines the operation state of a target machine for each time slot and for each classification provided according to a classification condition. The analysis device 100 decides a time slot during which at least a prescribed proportion of classifications exhibit a specific operation state. In this way, a time slot during which the same operation state is observed can be identified irrespective of classification. Operation states each involve different power consumption. Accordingly, it can be said that the analysis device 100 according to embodiments can decide the trend of power consumption.

According to the analysis system 1 in embodiments, the analysis device 100 causes the display device 200 to display the operation state of the target machine for each classification and for each time slot. The analysis device 100 also causes the display device 200 to display a time slot during which at least a prescribed proportion of classifications exhibit a specific operation state.

According to the analysis system 1 in embodiments, the analysis device 100 causes the display device 200 to display the operation state of the target machine, with the time axes for the individual classifications being aligned. Thus, the operation state can be easily identified. It is also easy to identify a time slot during which at least a prescribed proportion of classifications exhibit a specific operation state.

According to the analysis system 1 in embodiments, the analysis device 100 considers that the state in which the power is on but no operation is performed is the stopped state. Thus, it is found to be likely that the analysis device 100 in the stopped state can be powered off.

According to the analysis system 1 in embodiments, the analysis device 100 considers that the state in which no operation for machining a workpiece is performed is the stopped state. Thus, it is found to be likely that the analysis device 100 in the stopped state can be powered off.

According to the analysis system 1 in embodiments, the analysis device 100 considers that the state in which neither an operation for machining a workpiece nor an operation for moving an axis is performed is the stopped state. Thus, it is found to be likely that the analysis device 100 in the stopped state can be powered off.

According to the analysis system 1 in embodiments, the analysis device 100 notifies when a time slot during which at least a prescribed proportion of classifications exhibit a specific operation state has been entered. Thus, the analysis device 100 according to embodiments can encourage turning off the power when the time slot has been entered.

According to the analysis system 1 in embodiments, the analysis device 100 decides a time slot during which at least a prescribed proportion of classifications exhibit the stopped state. Thus, it can be found during which time slot an unoperated industrial machine 400 is in the power-ON state. The amount of power consumption can possibly be reduced by powering off the industrial machine 400 during this time slot. The ability to reduce the amount of power consumption leads to energy saving and can reduce environmental impact.

The following variations of the embodiments described above are also possible.

In the embodiments described above, at least a target machine, a target period, or a classification condition can be changed by operating the button BT1. However, the processor 101 may perform the processes of Steps ST15 to ST20 while automatically changing at least the target machine, the target period, or the classification condition. In this case, for example, the processor 101 returns to Step ST12 when having given a decision of No in Step ST19. Then, after the process of Step ST20, the processor 101 returns to Step ST12. Afterward, the processor 101 automatically changes at least the target machine, the target period, or the classification condition in the processes of Steps ST12 to ST14.

In the embodiments described above, there is an assessment region in a time slot during which at least a prescribed proportion of classifications exhibit the stopped state. However, there may be an assessment region in a time slot during which at least a prescribed proportion of classifications exhibit another operation state, other than the stopped state.

In the embodiments described above, power consumers are industrial machines 400. However, power consumers in embodiments may be machines other than the industrial machines 400. A power consumer in embodiments may be, for example, peripheral equipment. A power consumer in embodiments may be a portion of a machine. A power consumer in embodiments may be, for example, a system formed from a plurality of machines. The system may include, for example, peripheral equipment.

Examples of portions of a machine may be, for example, individual motors included in the machine. In this case, the analysis device 100 analyzes a power consumption status on the assumption that each motor is one power consumer.

By using the hardware configuration of a circuit, the processor 101 may implement a portion of or the entirety of the processing implemented by a program in the embodiments described above.

The program for implementing the processing in embodiments is handed over in, for example, a state of being stored in a device. However, this device may be handed over without the program being stored therein. The program may be handed over separately and written to the device. For example, the handover of the program in this situation can be achieved by recording the same in a removable recording medium or by downloading the same via a network such as the Internet or a LAN.

Although embodiments of the present invention have been described, such embodiments are indicated as examples and do not limit the scope of the present invention. Embodiments of the present invention can be implemented in various aspects without departing from the gist of the present invention.

### EXPLANATION OF REFERENCE NUMERALS

1: Analysis system
100: Analysis device
101: Processor
102: ROM
103: RAM
104: Auxiliary storage device
105: Communication interface
106: Display interface
107: Input interface
108: Bus
200: Display device
300: Input device
400: Industrial machine

1. An analysis device comprising:
an obtainment unit that obtains an operation status of at least one power consumer;
a determination unit that determines, by using the operation status and for each of time slots and for each of a plurality of classifications provided according to a condition, an operation state that the power consumer is in from among a plurality of operation states each involving different power consumption; and
a decision unit that decides a time slot during which at least a prescribed proportion of the classifications share a common operation state.

2. The analysis device according to claim 1, further comprising:
a display control unit that causes a display unit to display the operation state for each of the time slots and for each of the classifications for which the determination unit has made the determination, and to display the time slot decided by the decision unit.

3. The analysis device according to claim 2, wherein
the display control unit causes the respective operation states for the classifications to be displayed, with time axes being aligned.

4. The analysis device according to claim 1, further comprising:
a notification unit that notifies that a current time has reached a time decided by the decision unit.

5. The analysis device according to claim 1, wherein
the common operation state is a stopped state in which power is on but no operation is performed.

6. The analysis device according to claim 5, wherein
the operation is an operation for machining a workpiece.

7. The analysis device according to claim 5, wherein
the operation is at least an operation for machining a workpiece or an operation for moving an axis for machining the workpiece.

8. An analysis system comprising:
at least one power consumer; and
an analysis device, wherein
the analysis device includes
an obtainment unit that obtains an operation status of the at least one power consumer,
a determination unit that determines, by using the operation status and for each of time slots and for each of a plurality of classifications provided according to a condition, an operation state that the power consumer is in from among a plurality of operation states each involving different power consumption, and
a decision unit that decides a time slot during which at least a prescribed proportion of the classifications share a common operation state.

9. A non-transitory computer readable medium storing a program for causing a processor of an analysis device to function as:
an obtainment unit that obtains an operation status of at least one power consumer;
a determination unit that determines, by using the operation status and for each of time slots and for each of a plurality of classifications, an operation state that the power consumer is in from among a plurality of operation states each involving different power consumption; and
a decision unit that decides a time slot during which at least a prescribed proportion of the classifications share a common operation state.
